(19) United States
(12) Patent Application Publication
(10) Pub. No.: US 2011/0119473 A1
(43) Pub. Date: May 19, 2011

(54) Virtual Platform Configuration Validation

(75) Inventors: Jani Hyvonen, Tampere (FI); Tino Rautiainen, Ylinen (FI)

(73) Assignee: Nokia Corporation, Espoo (FI)

(21) Appl. No.: 12/905,904

(22) Filed: Oct. 15, 2010

Related U.S. Application Data
(60) Provisional application No. 61/252,108, filed on Oct. 15, 2009.

(51) Int. Cl. G06F 9/24

(52) U.S. Cl. 713/1

(57) ABSTRACT

Systems and methods are provided for unambiguously checking and/or validating a hardware configuration. Configuration rules based upon an actual hardware specification are written and applied to a software use case before the software use case is run. Actual hardware is modeled to create a virtual hardware via a virtual platform system. Upon initiating execution of the software use case on the virtual hardware, a comparison is performed to determine if current settings pertaining to the virtual hardware matches the configuration rules applicable to the software use case. If the configuration rules match the current settings, the software use case can be run on the virtual hardware. If the configuration rules do not match the current settings, execution of the software use case can be stopped and/or alternatively, a notification can be generated, where the notification indicates that the configuration rules and the current settings do not match.

### FIELD

Various embodiments relate generally to virtual platforms utilized for developing hardware-compatible software prior to the availability of the hardware. More particularly, various embodiments relate to providing unambiguous validation for a hardware configuration supported by a virtual platform.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Virtual platforms refer to, e.g., software models of systems or hardware and/or tools that create such models, that provide software developers with “pre-silicon” software development environments or hardware look-alike platforms. The software being developed can be run as though it were being run on top of/over real hardware. That is, virtual platforms may be used for developing hardware-compatible software prior to the actual system or hardware being available. For example, virtual platforms may be utilized prior to hardware wakeup (e.g., when the developed software is implemented on actual hardware). Additionally, virtual platforms allow for virtual prototyping, utilizing simulated application specific integrated circuit (ASIC) chips and hardware operating on a personal computer (PC) environment, etc. Examples of conventional virtual platform tools include, but are not limited to, VaST virtual system prototypes, the ARM System Generator tool for virtual prototype generation; Synopsys Virtio virtual platform software models, and the QEMU open source processor emulator.

However, developing software on top of a virtual platform incurs a risk that the virtual platform does not behave exactly in the same manner as the hardware will actually behave. This may lead to situations where developed software runs/operates correctly on the virtual platform, but fails to run/operate correctly on top of the actual hardware when the hardware becomes available. For example, virtual platforms are generally constructed by utilizing a hardware or system specification as a base. More specifically, a particular configuration is set for each hardware use case that is to be run. A configuration involves or results from the setting of a correct functionality to, e.g., an ASIC pin, enabling and configuring any needed clocks, enabling and configuring any voltage regulators that are required, etc.

Conventional virtual platform models may check certain criteria. For example, a platform peripheral may check whether a clock signal for the platform peripheral is enabled, if such a clock signal has been modeled. Additionally, a peripheral specification may have certain rules for software access, where the rules may or may not have been implemented in the software code of the peripheral model. Further still, it is possible that before a virtual platform becomes available, a hardware configuration has already been implemented and validated on top of real hardware. However, conventional virtual platform implementations still fail to efficiently validate hardware configuration.

### SUMMARY OF VARIOUS EMBODIMENTS

In accordance with various embodiments, a virtual platform system is provided that unambiguously checks and/or validates a hardware configuration. Configuration rules based upon an actual hardware specification are written and applied to a software use case before the software use case is run. Prior to any actual hardware being available, the actual hardware is modeled to create virtual hardware on a virtual platform system. Upon initiating execution of the software use case on the virtual hardware, a comparison is performed to determine if current settings pertaining to the virtual hardware matches the configuration rules applicable to the software use case. If the configuration rules match the current settings, the software use case can be run on the virtual hardware. If the configuration rules do not match the current settings, execution of the software use case can be stopped and/or alternatively, a notification can be generated, where the notification indicates that the configuration rules and the current settings do not match.

Utilizing various embodiments reduces the risk that software developed via a virtual platform will not run/run properly on the actual hardware the software is intended to be executed on. Additionally, various embodiments allow for the possibility of faster and more successful hardware wake-up when the actual hardware becomes available, and for the developed software to properly execute/run on the actual hardware. Additionally, validating software on a virtual platform system in accordance with various embodiments results in better quality software upon actual implementation, thus making it possible to implement more software use cases with better quality prior to hardware availability.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 is representative of an exemplary message flow that occurs between various aspects of a virtual platform system in accordance with various embodiments;

FIG. 2 is a flowchart illustrating exemplary processes performed in accordance with various embodiments for validating hardware configuration;

FIG. 3 is an overview diagram of a system within which various hardware whose configuration is validated in accordance with various embodiments may be utilized;

FIG. 4 is a perspective view of an electronic device that may be modeled utilizing various embodiments;

FIG. 5 is a schematic representation of the circuitry which may be included in the electronic device of FIG. 4;

### DETAILED DESCRIPTION OF VARIOUS EMBODIMENTS

As described above, before software can be run on hardware, the software should be configured to correctly coincide with the hardware's specifications. Examples of such configurations include, but are not limited to, pin out, clock, and power configurations, or any other relevant/applicable register settings or configurations. Pin out configuration may refer to function muxing, pull up/down configuration, etc. Clock configuration may refer to enabling clocks, frequencies, clock signal polarity settings, etc. Power configuration may refer to voltage levels, memory states, power states (power down, retention), etc.

For example, and with regard to pin configurations, items such as the afore-mentioned pin functional muxing and pin pull up/down configuration should be identical to the hardware (upon which the software will be run/executed upon) in a manner such that if a pin is configured incorrectly, the intended functionality of the pin will not work. Likewise and for example, clock and power configuration should also be supported, where again, the clock and/or power configuration shall be identical to the hardware (upon which the software will be run/executed upon) so that if the clock and/or power items/aspects are incorrectly configured, the intended functionality will not work. It should be noted, however, that in accordance with various embodiments, it is possible to bypass such a feature. Bypassing such a feature would be for convenience/efficiency purposes. That is, bypassing the feature would enable, e.g., a software developer, to continue other aspects of the software development process in spite of such inconsistencies.

As also described above, conventional virtual platform models/tools fail to efficiently validate hardware configuration. Various embodiments described herein provide a virtual platform system and method that has the ability to unambiguously check and/or validate a hardware configuration. In accordance with various embodiments, configuration rules specified by a hardware specification are written and validated before a software use case is run/executed. If a currently-set configuration matches specified configuration criteria, the software use case can be run on the virtual platform hardware.

In accordance with various embodiments, a set of configuration rules is written for a system based on a hardware specification. The set of rules may be written by, e.g., development personnel or a development group that is responsible for designing the functionality of the actual hardware. Alternatively, the set of rules may be written by other entities. It should be noted that the set of configuration rules may be written in an Extensible Markup Language (XML) or some other format easily readable by the virtual platform system. The virtual platform system is “extended” with the capability of reading the configuration rules and comparing the configuration rules to the current settings of the virtual platform hardware.

When a software use case is run on top of virtual platform hardware, the virtual platform system checks that the virtual platform hardware configuration setting matches the configuration rules pertaining to a software use case. When there is a match between the configuration rules (set for the software use case and read by the virtual platform system) and the current settings of the virtual platform hardware, the software use case may be run normally. In the event that a match cannot be made or determined, the virtual platform system may stop the execution of the currently run software use case. Alternatively or in addition to stopping execution of the software use case, the virtual platform system may generate a notification, alarm, etc. to, e.g., a user, such as a software developer, indicating that the configuration of the virtual platform system is “illegal.” Moreover, along with the notification, certain information regarding the inability to match the configuration rules and current settings, any problems resulting in the inability, etc. may be provided so that the software developer can easily identify a missing or incorrect configuration and correct the issue.

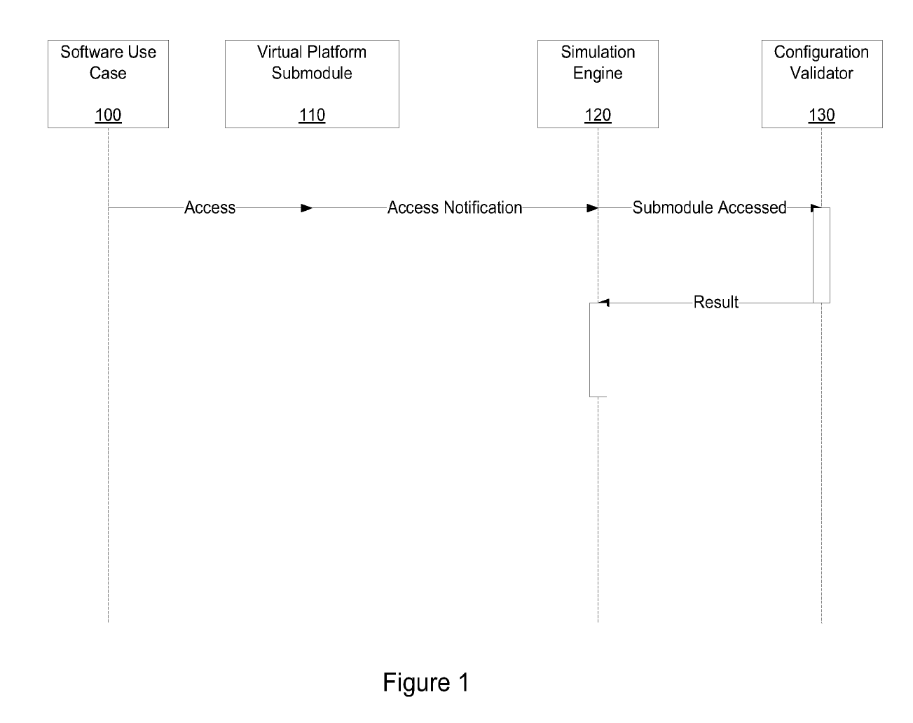

FIG. 1 illustrates an exemplary message flow that occurs in an exemplary virtual platform system in accordance with various embodiments. A software use case 100 accesses a virtual platform submodule 110. The virtual platform submodule 110 may be representative of, e.g., a peripheral controller, or some other component of the actual hardware that the virtual platform system is modeling. The accessing of the virtual platform submodule 110 may refer, for example, to a read or write operation to a control register of the virtual platform submodule 110. A simulation engine 120 is notified of the access. The simulation engine 120 checks whether the configuration check functionality described above is turned on. If so, the simulation engine 120 performs the following respective actions. When the configuration check functionality is on, the simulation engine 120 notifies a configuration validator 130 about the access to the virtual platform submodule 110. The configuration validator 130 reads the applicable configuration rules information written and set for the virtual platform submodule 110 use case and compares the configuration rules to the current settings of the virtual platform hardware. The comparison that is performed may be based, e.g., on any register settings or contents. For example, certain preconditions regarding the following pin out and clock configurations may be checked/compared.

<<precondition>>
{Function mux pinx==sub110
Pinx pull active==on
Pinx pull down==on
Functional clock sub110==on
Interface clock sub110==on
Interface clock sub110 frequency==50 Mhz

After the comparison is performed, the configuration validator 130 returns a result of the comparison to the simulation engine 120. Based upon the result of the comparison, the simulation engine 120 either allows or denies access to and/or usage of the virtual platform submodule 110. That is, if the configuration rules match the current settings of the virtual platform hardware, access to the virtual platform submodule 110 is allowed, and the software use case can be run. If the configuration rules do not match the current settings of the virtual platform hardware, access to the virtual platform submodule 110 is denied and execution of the software use case is, e.g., stopped. In addition to, or in the alternative to stopping execution of the software use case, the virtual platform system can send out a notification indicating the presence of a problem regarding configuration. For example, the virtual platform system may be configured to print an information message to a virtual platform system user containing, e.g., detailed information, regarding the failure of/possibility of the failure of the comparison.

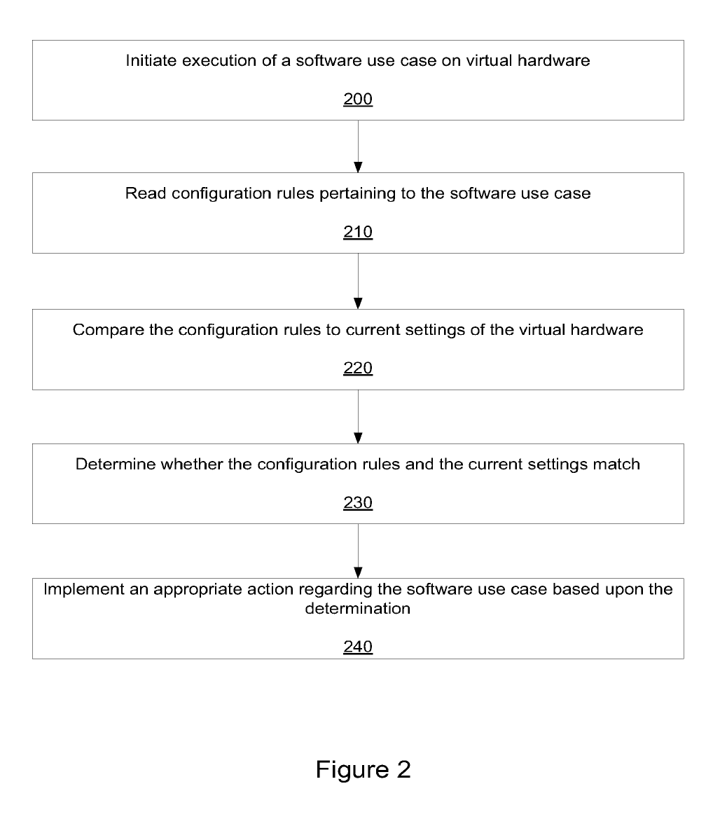

FIG. 2 is a flowchart illustrating exemplary processes performed in accordance with various embodiments. At 200, execution of a software use case on virtual hardware is initiated. As previously described, the virtual hardware may refer to, e.g., a virtual model of actual hardware upon which software including the software use case is to be implemented. The modeling of the virtual hardware may be generated by or performed by a virtual platform system. At 210, configuration rules pertaining to the software use case are read. The configuration rules may be written for the software use case based upon a hardware specification of the “not-yet-available” actual hardware, e.g., one or more register settings or configurations. At 220, a comparison is made between the configuration rules and the current settings of the virtual hardware. At 230, it is determined whether the configuration rules and the current settings match. At 240, an appropriate action is implemented regarding the software use case based upon the determination. For example, and as described above, the virtual platform may stop execution of the software run case and/or may generate some type of notification/alarm indicating that the configuration rules and the current settings do not match. Alternatively, the software use case may continue to run if a match is made.

As a result of utilizing a virtual platform system in accordance with various embodiments, the risk that software written or developed using a virtual platform as an execution platform will not run on top of actual hardware is minimized. Minimizing such risk as much as possible allows for easier achievement of fast and successful hardware wake-up when the actual hardware arrives, and the successful implementation/execution of the developed software on the actual hardware. Additionally, software developers can be more confident about rolling out software. That is, validating software on a virtual platform system in accordance with various embodiments results in better quality software upon actual implementation, thus making it possible to implement more software use cases with better quality prior to hardware availability. Further still, various measures can be taken to reduce or eliminate any potential slowing down of the operating speed of such virtual platform systems, and/or the comparison/validation may be configured to be selectively enabled or disabled as desired.

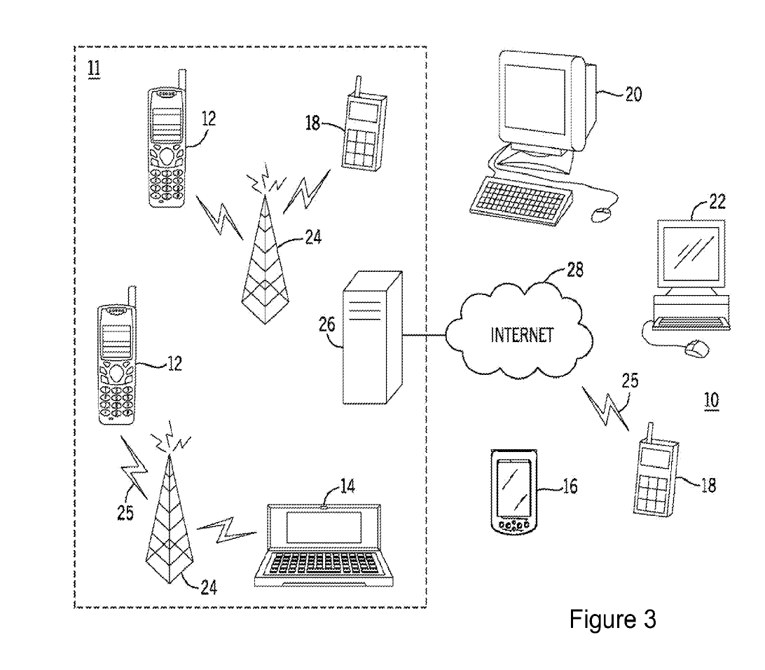

FIG. 3 shows a system 10 within which various hardware whose configuration may be validated in accordance with various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 3 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types. Any of the aforementioned devices or system elements may utilize/execute software in conjunction with their operation, where the software utilized/executed may be developed using a virtual platform system that, e.g., models such devices or system elements, in accordance with various embodiments.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

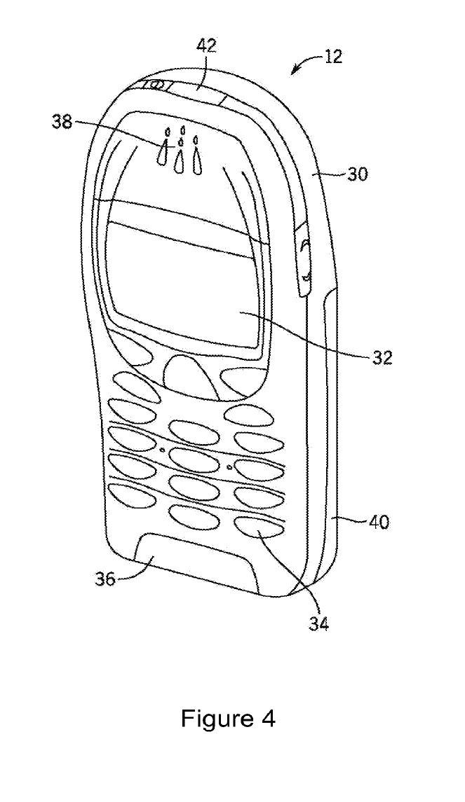

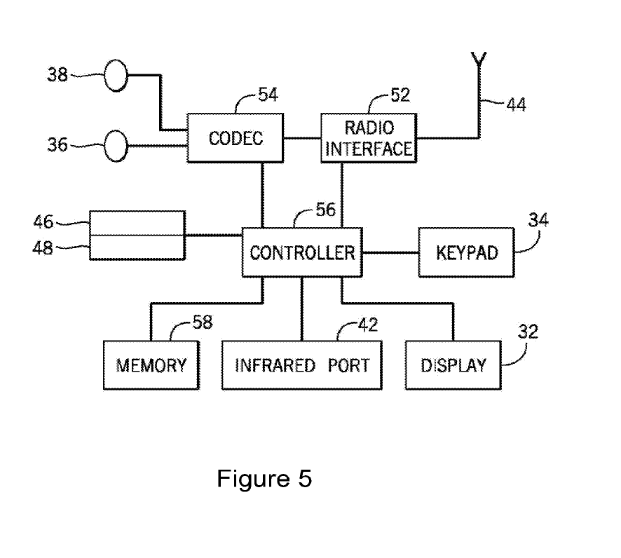

FIGS. 4 and 5 show one representative electronic device 12 for which software may be developed in accordance with various embodiments. It should be understood, however, that various embodiments are not intended to be applicable to one particular type of device. The electronic device 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58, the aspects of which may be modeled in accordance with various embodiments. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1. A method, comprising:
initiating execution of a software use case on virtual hardware;
reading configuration rules pertaining to the software use case;
comparing the configuration rules to current settings of the virtual hardware;
determining whether the configuration piles and the current settings match; and
implementing an appropriate action regarding the software use case based upon the determination.

2. The method according to claim 1, wherein the software use case, at least in part, comprises software being developed for use on actual hardware modeled as the virtual hardware.

3. The method according to claim 2, wherein development of the software occurs prior to availability of the actual hardware.

4. The method according to claim 1, wherein the configuration rules are written based upon a hardware specification pertaining to actual hardware modeled as the virtual hardware.

5. The method according to claim 1, wherein the configuration rules pertain to at least one register setting associated with actual hardware modeled as the virtual hardware.

6. The method according to claim 1, wherein the implementation of the appropriate action comprises stopping execution of the software use case upon the determination that the configuration rules and the current settings do not match.

7. The method according to claim 1, wherein the implementation of the appropriate action comprises generating a notification indicative of the determination that the configuration rules and the current settings do not match.

8. The method according to claim 1, wherein the implementation of the appropriate action comprises at least one of continuing the execution of the software use case and allowing the execution of the software use case.

9. The method according to claim 1 further comprising, selectively enabling the reading of the configuration rules pertaining to the software use case, the comparing of the configuration rules to the current settings of the virtual hardware, and the determining of whether the configuration rules and the current settings match.

10. An apparatus, comprising:
a processor; and
a memory unit operatively connected to the processor and including:
computer code executable by the processor and configured to initiate execution of a software use case on virtual hardware;
computer code executable by the processor and configured to read configuration rules pertaining to the software use case;
computer code executable by the processor and configured to compare the configuration rules to current settings of the virtual hardware;
computer code executable by the processor and configured to determine whether the configuration rules and the current settings match; and
computer code executable by the processor and configured to implement an appropriate action regarding the software use case based upon the determination.

11. The apparatus according to claim 10, wherein the software use case, at least in part, comprises software being developed for use on actual hardware modeled as the virtual hardware.

12. The apparatus according to claim 11, wherein development of the software occurs prior to availability of the actual hardware.

13. The apparatus according to claim 10, wherein the configuration rules are written based upon a hardware specification pertaining to actual hardware modeled as the virtual hardware.

14. The apparatus according to claim 10, wherein the configuration rules pertain to at least one register setting associated with actual hardware modeled as the virtual hardware.

15. The apparatus according to claim 10, wherein the implementation of the appropriate action comprises stopping execution of the software use case upon the determination that the configuration rules and the current settings do not match.

16. The apparatus according to claim 10, wherein the implementation of the appropriate action comprises generating a notification indicative of the determination that the configuration rules and the current settings do not match.

17. The apparatus according to claim 10, wherein the implementation of the appropriate action comprises at least one of continuing the execution of the software use case and allowing the execution of the software use case.

18. The apparatus according to claim 10, wherein the memory unit further comprises computer code executable by the processor and configured to receive instructions to selectively enable the computer code executable by the processor and configured to read the configuration rules pertaining to the software use case, the computer code executable by the processor and configured to compare the configuration rules to the current settings of the virtual hardware, and the computer code executable by the processor and configured to determine whether the configuration rules and the current settings match.

19. A computer program product, embodied on a non-transitory computer-readable medium, comprising computer code executable on a processor configured to:
initiate execution of a software use case on virtual hardware;
read configuration rules pertaining to the software use case;
compare the configuration rules to current settings of the virtual hardware;
determine whether the configuration rules and the current settings match; and
implement an appropriate action regarding the software use case based upon the determination.

20. The computer program product according to claim 19, further comprising computer code executable on a processor configured to:
selectively enable the reading of the configuration rules pertaining to the software use case, the comparing of the configuration rules to the current settings of the virtual hardware, and the determining of whether the configuration rules and the current settings match.
